(19) United States
(12) Patent Application Publication
(10) Pub. No.: US 2016/0012657 A1
(43) Pub. Date: Jan. 14, 2016

(54) EFFICIENT AUTHENTICATION FOR FUELING OF VEHICLES

(71) Applicants: Stacey Reineccius, San Francisco, CA (US); Franklin Gobar, San Rafael, CA (US); John C. Sellers, El Cerrito, CA (US)

(72) Inventors: Stacey Reineccius, San Francisco, CA (US); Franklin Gobar, San Rafael, CA (US); John C. Sellers, El Cerrito, CA (US)

(21) Appl. No.: 14/326,316

(22) Filed: Jul. 8, 2014

(51) Int. Cl. G07C 9/00; G06Q 20/22

(52) U.S. Cl. CPC G07C 9/00126; G06Q 20/22

(57) ABSTRACT

Systems, methods, and devices for authorizing a vehicle for refueling are discussed herein. A method for authorizing a vehicle includes maintaining a list of preauthorized vehicles. The list of preauthorized vehicles includes entries uniquely corresponding to specific preauthorized vehicles. The list is maintained at a geographical charging site remote from one or more geographical charging locations. The method also includes transmitting to the geographical charging sites an update to the list of preauthorized vehicles. Each geographical charging site may include one or more charging stations. The method further includes receiving usage updates for the one or more geographical charging sites.

### TECHNICAL FIELD

The present disclosure relates to vehicle refueling and more particularly relates to vehicle identification for refueling.

### BRIEF DESCRIPTION OF THE DRAWINGS

FIG. 1 is a schematic diagram illustrating a fuel distribution system consistent with embodiments disclosed herein.

FIG. 2 is a schematic diagram illustrating a site controller consistent with embodiments disclosed herein.

FIG. 3 is a schematic diagram illustrating a vehicle fueling interface consistent with embodiments disclosed herein.

FIG. 4A is an exploded view of an outlet plug of a fuel distribution station consistent with the embodiments disclosed herein.

FIG. 4B is an assembled view of the outlet plug of FIG. 4A consistent with the embodiments disclosed herein.

FIG. 4C is a front view of an outlet plug tip with notches consistent with embodiments disclosed herein.

FIG. 4D is a perspective view of an outlet plug tip with notches consistent with embodiments disclosed herein.

FIG. 5A is a schematic block diagram illustrating electrical interconnection between portions of a fuel distribution station consistent with embodiments disclosed herein.

FIG. 5B is another schematic block diagram illustrating electrical interconnection between portions of a fuel distribution station consistent with embodiments disclosed herein.

FIG. 6A is a perspective view of a vehicle inlet consistent with embodiments disclosed herein.

FIG. 6B is another perspective view of a vehicle inlet consistent with embodiments disclosed herein.

FIG. 7A is an exploded perspective view of a bezel consistent with embodiments disclosed herein.

FIG. 7B is another exploded perspective view of a bezel consistent with embodiments disclosed herein.

FIG. 8 is a perspective view of a bezel assembly and an applicator consistent with embodiments disclosed herein.

FIG. 9 is a perspective view of an applicator applying a bezel assembly to a vehicle inlet consistent with embodiments disclosed herein.

FIG. 10 is a perspective view of a vehicle and a fuel distribution station during refueling consistent with embodiments disclosed herein.

FIG. 11 is a schematic flow chart diagram illustrating a method for providing a refueling subscription consistent with embodiments disclosed herein.

FIG. 12 is a schematic flow chart diagram illustrating a method for managing a list of preauthorized vehicles consistent with embodiments disclosed herein.

FIGS. 13A, 13B, and 13C are schematic flow chart diagrams illustrating a communication and processing flow for authorizing vehicles at a refueling site consistent with embodiments disclosed herein.

FIG. 14 is a schematic flow chart diagram illustrating a method for authorizing a vehicle to use a refueling station consistent with embodiments disclosed herein.

### DETAILED DESCRIPTION OF PREFERRED EMBODIMENTS

Vehicle refueling systems generally operate in an unprotected mode or a protected mode. In an unprotected mode, or promiscuous mode, anyone with physical access to the refueling system is allowed to refuel without authentication or payment. In a protected mode, users are generally required to authenticate or pay in some manner before being allowed to refuel a vehicle. Generally, payment or authentication is performed using a card, such as a payment card or authentication card, that can be read by a reader of the refueling system. Example payment cards include credit cards, debit cards, or the like. Example authentication cards include any type of employee card, membership card, or even payment card that may be used to authorize refueling. Generally, payment cards and authentication cards are in a form similar to a credit card, key ring mounted card, or the like. These authentication, payment, and identification cards are generally read using a card reader, such as a magnetic card reader, an RFID card reader, or other type of contact or proximity reader.

However, these methods for refueling have a number of significant limitations and disadvantages. First, the above methods make it difficult or impossible to identify the specific vehicle that is being refueled. Because the authentication or payment cards can be passed from one person to the next, the cards may be shared and the same card may be used to fuel multiple vehicles. This loaning potential makes it impossible to be reasonably certain that a specific vehicle is being fueled or that fueling privileges are being used correctly. This allows for potential theft of service and prevents certainty in knowledge of costs and, as such, presents limits on potential service offerings attractive to customers. Furthermore, dissociated tags or cards can lead to issues in customer experience, such as lost or duplicated tags or cards, and waits to establish a session for service delivery.

Second, the above methods require significant physical and communication infrastructure. For example, credit card readers, display screens, high speed communication connections, and the like are required in order to process payments and/or authenticate an individual or card. Both the physical infrastructure and communication subscriptions add to the cost of refueling for the customer.

Third, a significant amount of manual interaction with an authentication device is required each time a vehicle is refueled. For example, a user may need to swipe a card, enter a personal identification number, and wait for a remote server to authorize fueling, all before any refueling can begin to take place. Furthermore, the cards must be carried by the user, and loss of the authorization card presents inconvenience and, likely, loss of service to the customer.

Fourth, payment and authorization with a remote server must be performed for each refueling occurrence. This results in higher communication demands and also introduces the potential for credit card transaction fees and bank fees with every refueling transaction. In telecommunications, for example, per transaction billing systems eat as much as 50% of the total profit generated from calls versus flat rate plans that utilize less than 10%. Furthermore, no revenue can be recognized from the station unless a transaction is completed under generally accepted accounting principles (GAAP). This makes it impossible to provide a certainty of revenue recognition timing, further complicating accounting and raising per transaction costs.

The above discussed limitations result in significant limits on the types of subscriptions and services that can be provided to customers. For example, customers are required to pay, based on either the unit of time or the unit of fuel delivered upon each refueling occurrence. Because either the unit time or the unit energy delivered must be tracked for each transaction, tracking costs must be taken into account and charged to the customer. Similarly, costs for customer support and revenue recognition must also be accounted for. In some cases, tracking, customer support, and revenue recognition can add significant costs that can even be equal to or greater than the cost of fuel provided. For example, the overhead costs for a fuel distribution station to operate can match or be even greater than the cost of the fuel that is provided.

Based on the foregoing, applicants have recognized that a need exists for simpler and faster identification, as well as for secure identification and authentication for a specific vehicle. Applicants have recognized that, by identifying a specific vehicle, certainty as to identity and fueling requirements can be obtained, convenience can be improved for the customer, and complexity of billing management can be reduced, along with the associated costs for such fuel service delivery. Additionally, identifying a specific vehicle, rather than an operator, a card, an account, or other entity that can be separated or dissociated from the vehicle, allows for subscription-based refueling where the specific vehicle may be refueled an unlimited amount within a specific subscription period.

As used herein, the terms “refueling,” “fueling,” and the like are given to encompass any form of replenishing fuel, an electric charge, or any other energy source for a vehicle or other energy consumption device. For example, the terms “refueling” and “fueling” are given to encompass providing a liquid fuel, a gaseous fuel, or even recharging batteries. Similarly, as used herein, the term “fuel” is given to mean any energy in whatever form consumed by a vehicle or energy consumption device. For example, the term “fuel,” as used herein, is given to encompass any liquid or gaseous fuel, such as gasoline or hydrogen. The term “fuel” is also given to encompass other forms of energy such as electricity, electrical charge, and the like.

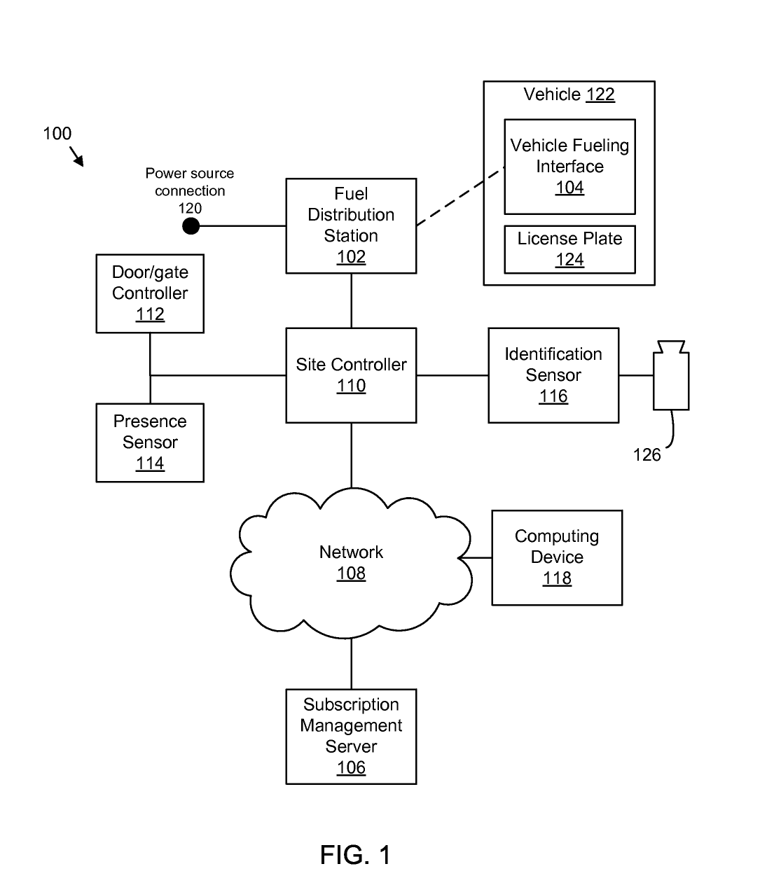

Turning to the figures, FIG. 1 is a schematic diagram illustrating a fuel distribution system 100. The fuel distribution system 100 includes a fuel distribution station 102, a vehicle fueling interface 104, and a subscription management server 106. A site controller 110 is in communication with the fuel distribution station 102 and the subscription management server 106. A door/gate controller 112, a presence sensor 114, and an identification sensor 116 are in communication with the site controller 110. The subscription management server 106 and the site controller 110 are shown in communication over a network 108. The fuel distribution system 100 may be configured to refuel a vehicle or other refuelable or rechargeable device.

The fuel distribution station 102 may include any type of refueling station. For example, the fuel distribution station 102 may include a gas station with one or more pumps and/or may include a recharging station with one or more outlet plugs. For example, the fuel distribution station 102 may represent each fuel pump at a gas station or recharging station. Alternatively, a single fuel distribution station 102 may have multiple outlets or pumps. The fuel distribution station 102 may be configured to uniquely identify a vehicle and determine whether the vehicle is authorized for refueling. According to one embodiment, the fuel distribution station 102 is located at a fixed site where vehicles may arrive to be refueled. Example fuel distribution stations 102 on the market which may be used as the fuel distribution station 102 include stations available through Chargepoint®, Eaton®, Aeronvironment®, among others. In one embodiment, the fuel distribution station 102 has a connection 120 to a power source, such as the electrical grid, a battery, and/or an electrical power generation system (e.g., photovoltaic cells or the like). The fuel distribution station 102, in one embodiment, may selectively provide electrical energy from the power source connection 120 to the vehicle fueling interface 104 to charge a vehicle.

The fuel distribution station 102 may include a distribution interface to provide the fuel (gas, electricity, etc.) to the vehicle. The distribution interface is an interface configured to provide fuel to a vehicle. The distribution interface may be configured to couple with a fuel receiving interface of a vehicle, such as the fuel receiving interface 302 discussed in relation to the vehicle fueling interface 104 of FIG. 3.

In one embodiment, the distribution interface is configured to provide a liquid fuel to a vehicle. For example, the distribution interface may include tubing from a body of a gas pump and through a gas pump handle through which gasoline is provided to a vehicle. The fuel distribution station 102 may pump fuel through the distribution interface to fill up a gas tank or other storage system of the vehicle.

In another embodiment, the distribution interface is configured to provide electrical energy to a vehicle. For example, the distribution interface may include a power distribution interface for electrically coupling with and providing electrical power to a power receiving interface of a vehicle, such as the fuel receiving interface 302 discussed in relation to the vehicle fueling interface 104 of FIG. 3. In one embodiment, the power distribution interface includes a power cable extending from the fuel distribution station 102. The power distribution interface may include an outlet plug on the end of the power cable through which electrical energy may be passed to a vehicle. In one embodiment, the outlet plug, power cable, and other aspects of the distribution interface and/or the fuel distribution station 102 comply with a vehicle recharging standard. Examples of vehicle recharging standards include the Society of Automotive Eautomotive ngineers (SAE) J1772 standard, the CHAdeMO Association's “Charge de Move” (CHAdeMO) standard, a Tesla® standard, SAE Combo 2 standard, or the like. In some embodiments, outlet plugs or interfaces that comply with other recharging standards, derivatives of these standards, or proprietary interfaces may be used.

In one embodiment, the distribution interface may not need to physically contact a vehicle or the fuel receiving interface 302 of a vehicle to provide electrical power. For example, the distribution interface may include a wireless power coupling, such as an inductive charging interface, that is configured to electrically couple wirelessly with a wireless power coupling of a vehicle. The wireless power couplings of the distribution interface and the vehicle may include coils of wire with corresponding sizes. One of skill in the art will recognize considerable variation for wireless power couplings and/or proximity charging that may be used for refueling an electric vehicle.

In one embodiment, the distribution interface and/or the fuel distribution station 102 may include an indicator light to indicate a refueling status for a vehicle. For example, a single or multicolor indicator light may be controlled according to multiple states to indicate whether the distribution interface is connected with a vehicle, indicate whether a vehicle is authorized for refueling, indicate progress in the refueling process, and/or indicate whether refueling is complete.

According to one embodiment, the site controller 110 maintains identification information that corresponds to vehicles with active subscriptions. For example, the site controller 110 may maintain a list of identification information corresponding to vehicles which should be allowed to refuel at the fuel distribution station 102. The site controller 110 may allow any vehicle that has an active subscription to refuel at the fuel distribution station 102. Maintaining the identification information at the fuel distribution station 102 may significantly reduce communication costs because the subscription management server 106 may not be required to authenticate each refueling transaction with a remote device or server. For example, a list of active subscriptions may be maintained and compared with identification information to determine if the vehicle can be refueled without accessing a remote server or computer to authorize refueling.

The vehicle fueling interface 104 is configured to receive gas, electricity, or other fuel to refuel a vehicle. In one embodiment, the vehicle fueling interface 104 may include a fuel inlet, such as tubing, to receive a liquid fuel. In another embodiment, the vehicle fueling interface 104 includes an electrical inlet that includes conductors to receive electrical energy. The vehicle fueling interface 104 may be mounted on or in a body of a vehicle. For example, an electrical inlet may be integrated into a body of an electric powered vehicle and a fuel inlet may be integrated into a body of a gas powered vehicle. In one embodiment, the vehicle fueling interface 104 is permanently affixed to the vehicle such that it cannot be moved to another vehicle, or may only be moved with a key or specialized tool and/or damage to the vehicle and/or vehicle fueling interface 104. The vehicle fueling interface may be part of a vehicle 122. The vehicle may also include a license plate 124 that can be used to uniquely identify the vehicle 122.

The fuel distribution station 102 and the vehicle fueling interface 104 are connected by a dotted line to indicate that they may be configured to be selectively coupled. For example, the fuel distribution station 102 may be located at a fixed location where a vehicle that includes the vehicle fueling interface 104 may be periodically brought for refueling. In one embodiment, the fuel distribution station 102 includes an electrical outlet plug, while the vehicle fueling interface 104 includes an electrical vehicle inlet. In another embodiment, the fuel distribution station 102 includes a fuel pump handle for gasoline or other liquid fuel, while the vehicle fueling interface 104 includes a liquid fuel inlet into the vehicle. Some embodiments may include connectors configured to refuel using a gaseous fuel, such as hydrogen.

The subscription management server 106 may be a computing device that periodically provides updates to the identification information maintained by the fuel distribution station 102. For example, the subscription management server 106 may maintain a preauthorized list of vehicles that includes identification information for vehicles that have active subscriptions. The subscription management server 106 may periodically update this list, or upload changes to the list to the fuel distribution station 102. In one embodiment, the subscription management server 106 does not provide updates in a real-time manner. For example, the subscription management server 106 may periodically provide updates based on all the changes that have occurred within an update period. The update period may include one hour, multiple hours, one day, one week, one month, or the like. The infrequent updates may result in significant savings in communication costs. In one embodiment, the per transaction costs can be reduced to one list update per update period or less, which may potentially save a significant amount. In one embodiment, the list includes entries only for those vehicles that are allowed to refuel. Thus, an authorization process may be a simple matter of comparing identification information for a vehicle to a list stored locally at the site controller to determine whether a vehicle should be allowed to refuel.

The door/gate controller 112 may include a controller to selectively open or close a gate or door. For example, the gate or door may be opened to allow a vehicle to enter a bay or parking spot and refuel using the fuel distribution station 102. The presence sensor 114 may detect the presence of a vehicle at the refueling site or fuel distribution station 102. For example, the presence sensor 114 may detect the presence of the vehicle when the vehicle is positioned to be refueled. The identification sensor 116 includes one or more sensors to determine identification information for a vehicle. For example, when a vehicle arrives at the refueling site or fuel distribution station 102, the identification sensor 116 may capture information which may be used to uniquely identify the vehicle. In one embodiment, the identification sensor 116 is in communication with a camera 126 or includes a camera, which may be used to determine a vehicle model, license plate information, or other information visually available on the vehicle. For example, the camera 126 may be used to capture images of a license plate 124 and the identification sensor or site controller 110 may read the license plate number or other information using optical character recognition (OCR). In one embodiment, the identification sensor 116 includes an antenna, a wired communication port, or other device for receiving wireless or wireless signals from the vehicle. The wired or wireless signals may be used to uniquely and/or securely identify the vehicle.

The site controller 110 may be connected to a plurality of fuel distribution stations 102 and corresponding sensors. For example, a refueling site may include two or more fuel distribution stations 102 each with a corresponding bay, stall, or parking spot. The site controller 110 may be connected to each of the fuel distribution stations 102 to manage operation of and refueling at the fuel distribution stations 102.

The fuel distribution system 100 may also include a computing device 118 in communication with the network 108. The computing device 118 may include any type of computing or communication device, such as a desktop computer, laptop computer, tablet computer, smartphone, personal digital assistance (PDA), or the like. In one embodiment, a user may use the computing device 118 to communicate with the subscription management server 106 to create an account and/or pay for services. For example, a user with a smartphone may arrive at a refueling site and scan a barcode to access a webpage or download a mobile application to establish a refueling subscription for a specific vehicle. The specific vehicle may then be allowed to refuel using the fuel distribution station 102.

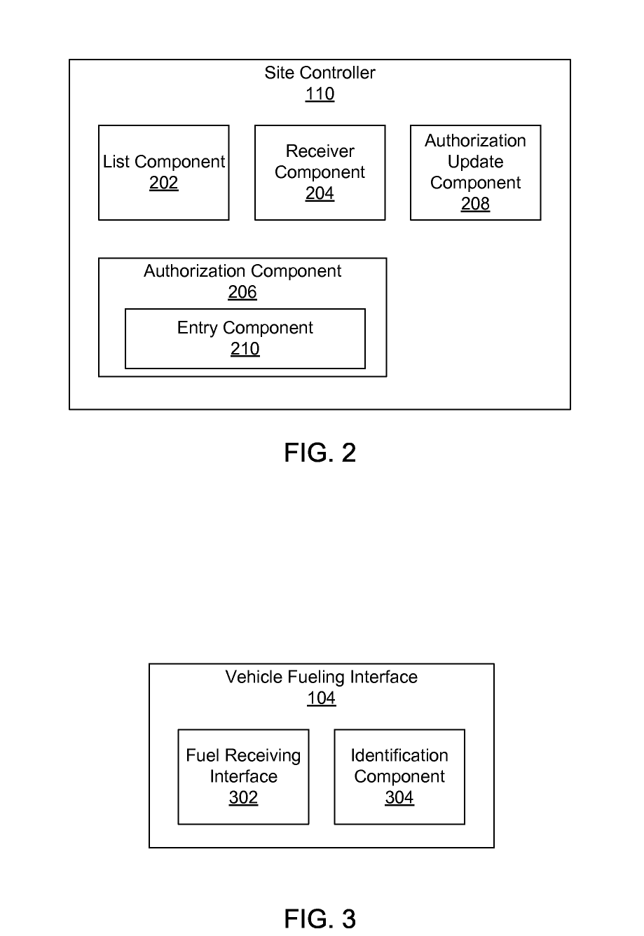

FIG. 2 is a schematic block diagram illustrating components of the controller 110. The site controller 110 fuel distribution station 102 includes a list component 202, a receiver component 204, an authorization component 206, and an authorization update component 208. The authorization component 206 includes an entry component 210. The components 202, 204, 206, 208, and 210 of the site controller 110 110 are given by way of example only. One or more of the components 202, 204, 206, and 208 may be omitted and/or additional components may be included, depending on the embodiment.

The list component 202 is configured to maintain a list of preauthorized vehicles. In one embodiment, the list includes entries uniquely corresponding to specific preauthorized vehicles. For example, each entry in the list may include identification information that uniquely corresponds to a single vehicle. The identification information may include an identifier stored in or on a vehicle, such as an identifier stored electrically within an identification tag, or other component of the vehicle. In one embodiment, the identifier may include an identifier of a wireless inductive charging interface on the vehicle. In one embodiment, the identifier may include license plate information, vehicle make and model information, color, or any other information that may help identify the vehicle. The list may be stored within memory of the site controller 110 or within a server or other electronic memory at the same refueling site as the site controller 110 and accessible by the site controller 110 without going over the Internet and/or a wide area network (WAN). The list may be maintained locally at the site controller 110 or a site of the fuel distribution station 102 such that no connection to the Internet or other large network is required to authorize refueling.

The receiver component 204 is configured to determine identification information for a vehicle. In one embodiment, the receiver component 204 is configured to receive the identification information from the vehicle. The receiver component 204 may receive identification information that uniquely identifies a vehicle. For example, the identification information may receive information from the identification sensor 116 of FIG. 1, such as a camera, communication port, wireless antenna, inductive charging interface, or the like. In one embodiment, the receiver component 204 receives information provided by a vehicle or components mounted on or in the vehicle. In one embodiment, the information is uniquely associated with the vehicle such that the receiver component 204 can accurately determine an identity of the vehicle.

In one embodiment, the receiver component 204 includes a tag reader that reads information from a tag mounted on the vehicle. For example, the receiver component 204 may include an RFID tag reader that may be used to read RFID tags on the vehicle. In one embodiment, each RFID tag on a vehicle includes unique identification information which may be used by the fuel distribution station 102 to identify the vehicle. In one embodiment, the receiver component 204 may query and/or receive identification information from tags or chips which communicate over a wired interface. For example, the receiver component 204 may include a tag reader configured to receive the identification information from a tag over a wired connection.

The receiver component 204 may be positioned to align with an identification component of a vehicle when the distribution interface is connected with the fuel receiving interface 302. For example, the receiver component 204 may be positioned such that it may receive identification information from the vehicle when the fuel receiving interface 302 of the vehicle fueling interface 104 is coupled to the distribution interface. In one embodiment, the receiver component 204 includes an antenna in the distribution interface that aligns with an RFID tag or other identification component of a vehicle when the fuel distribution station 102 and the vehicle fueling interface 104 are coupled for fueling. In one embodiment, the receiver component 204 may be located within a portion of the distribution interface, such as within an outlet plug, a power cable, a fuel pump handle, or other location of the fuel distribution station 102. In one embodiment, the receiver component 204 includes an RFID tag reader in an outlet plug of the distribution interface and the RFID tag reader includes an antenna to activate and/or receive data from an RFID tag.

The receiver component 204 may be in electrical communication with one or more conductors which electrically couple with a fuel receiving interface. For example, the receiver component 204 may contact a conductor which is in electrical communication with a tag or chip that is configured to relay identification information to the receiver component 204. For example, various recharging standards include a plurality of conductors to provide a ground line, a proximity line, power providing lines, communication lines, or the like. In one embodiment, the receiver component 204 may electrically connect to a conductor used in a recharging standard and receive the identification information via the conductor. For example, a proximity line, ground line, or other line may be used for the function indicated by the recharging standard as well as to provide/receive identification information corresponding to a vehicle. An identification component 304 may be similarly electrically connected to the corresponding line or conductor or may be configured to connect to the corresponding line or conductor when the distribution interface is coupled to a vehicle fueling interface 104.

In one embodiment, the receiver component 204 may receive the identification information in response to coupling of the distribution interface and the fuel receiving interface 302. For example, the receiver component 204 may be configured to query and/or receive the identification information in response to the distribution interface being coupled to the vehicle fueling interface 104. In one embodiment, the receiver component 204 includes an RFID tag reader that reads a passive, active, or battery assisted passive RFID tag. In one embodiment, the receiver component 204 includes a tag reader or other device that reads data transmitted over a wired connection with an identification component 304. In one embodiment, the tag reader provides a valid passcode to the tag or chip before the tag or chip will provide the identification information. In one embodiment, the receiver component 204 includes a transceiver to communicate with a tag, chip, or other device that provides identification data over a wired and/or wireless connection.

In one embodiment, the tag or other chip or device of the identification component 304 can store a unique security code that is changed by a signal from the vehicle fueling interface 104 after each fueling session and then sent by the fuel distribution station 102 and/or to the subscription management server 106 during the next regular periodic update for dissemination to other vehicle fueling stations. This security code can protect against a duplication of the tag and assures that a single vehicle ID can only be used in a single fueling session.

The authorization component 206 is configured to allow refueling of a vehicle based on identification information received by the receiver component 204. For example, the receiver component 204 may receive identification information and the authorization component 206 may determine whether the received identification information is valid and/or corresponds to an active account or subscription. In one embodiment, the authorization component 206 includes an entry component 210 which compares the identification information to the list of authorized identification information maintained by the list component 202. For example, if the entry component 210 determines that the identification information corresponds to an entry in the list, the authorization component 206 may determine that the vehicle is authorized for refueling. On the other hand, if the entry component 210 determines that the identification information does not correspond to an entry in the list, the authorization component 206 may deny refueling for the vehicle. If the identification is valid and/or corresponds to an active account or subscription, the authorization component 206 may authorize the refueling of the vehicle. For example, the authorization component 206 may allow electrical power, gasoline, hydrogen, or any other type of fuel to flow to the vehicle.

In one embodiment, the fuel distribution station 102 may include a flow component (not shown) for selectively allowing the flow of fuel to a vehicle. For example, the flow component may include an electrical switch, a pump, or other devices that can be used to selectively allow, cause, or block flow of a fuel to the vehicle. In one embodiment, the flow component of the fuel distribution station 102 may be controlled by the authorization component 206. For example, the authorization component 206 may send a message to the fuel distribution station 102 to place the flow component in a state that allows flow when a vehicle is authorized and may place the flow component in a state that does not allow flow when a vehicle is not authorized or the distribution interface is not connected to a vehicle.

The authorization update component 208 may periodically update information that indicates which vehicles are authorized for refueling. For example, the authorization update component 208 may periodically receive information from a subscription management server 106 to update a list of identification information that corresponds to vehicles which should be allowed to refuel. In one embodiment, the authorization update component 208 is configured to check for updates every minute or more, every hour or more, every day or more, or on some other time period. According to one embodiment, infrequent updates may decrease costs for a communication connection and thereby reduce fueling costs or subscription costs to customers. On the other hand, more frequent updates may allow for a fuel distribution station 102 to reflect a more current status for all vehicles that are allowed to be recharged. In one embodiment, the authorization update component 208 may only update the list when contacted by the subscription management server 106. For example, the subscription management server 106 may push changes to the site controller 110 when an update is needed and/or may update on any of the update periods discussed above.

FIG. 3 is a schematic block diagram illustrating components of the vehicle fueling interface 104. The vehicle fueling interface 104 includes a fuel receiving interface 302 and an identification component 304. Additional, fewer, or alternate components may be included in some embodiments.

The fuel receiving interface 302 is configured to receive fuel from the fuel distribution station 102. The fuel receiving interface 302 may be configured to couple with the distribution interface of the fuel distribution station 102, such as the distribution interface discussed above in relation to the fuel receiving interface 302 of FIG. 2. In one embodiment, the fuel receiving interface 302 is configured to receive liquid or gaseous fuel and direct it to a storage system of the vehicle. For example, the fuel receiving interface 302 may include a fuel inlet for a liquid or gaseous fuel and tubing from the inlet to a gas tank.

In another embodiment, the fuel receiving interface 302 includes a power receiving interface configured to electrically couple with and receive electrical power from the distribution interface. In one embodiment, the fuel receiving interface 302 includes a vehicle inlet that includes a conductor configured to physically mate with an outlet plug of the distribution interface. For example, the fuel receiving interface 302 may include a female inlet that includes conductors for contacting male outlet conductors of the distribution interface. In some embodiments, the vehicle inlet may include male connectors and the distribution interface may include female connectors. The electrical power may be used to recharge batteries, a fuel cell, capacitors, or other power storage system of a vehicle. The fuel receiving interface 302 may include an electrical inlet which may be used to receive electrical energy and pass it to a power storage system of the vehicle. In one embodiment, the vehicle inlet, power storage system, and other aspects of the vehicle fueling interface 104 and/or vehicle may comply with a vehicle recharging standard. Examples of vehicle recharging standards include the SAE J1772 standard, the CHAdeMO standard, or the like. In some embodiments, vehicle inlets that comply with other recharging standards or derivatives of these standards, without limitation, may be used.

In one embodiment, the fuel receiving interface 302 and the distribution interface may not need to make physical contact to electrically recharge a vehicle. For example, the fuel receiving interface 302 may include a wireless power coupling that is configured to electrically couple wirelessly with a wireless power coupling of the fuel distribution station 102. The wireless power couplings of the fuel receiving interface 302 and the fuel distribution station 102 may include coils of wire with corresponding sizes. One of skill in the art will recognize considerable variation for wireless power couplings and/or proximity charging that may be used for refueling an electric vehicle. For example, the wireless power coupling may be configured for wireless inductive charging with an inductive charger of the fuel distribution station 102.

The fuel receiving interface 302 and/or the vehicle fueling interface 104 may be integrated within a body of a vehicle. For example, the fuel receiving interface 302 may include tubing, wiring, and/or other portions that are integrated with a body of the vehicle. The fuel receiving interface 302 may be difficult or impossible to remove without damaging the fuel receiving interface 302 or the vehicle. According to one embodiment, a fuel receiving interface 302 that is integrated within a body of a vehicle is more difficult to remove or alter than a cable extending from the vehicle, or the like. For example, cables may be spliced, swapped, or modified more freely than an inlet mounted within the body of a vehicle.

The identification component 304 provides identification information to a fuel distribution station 102. The identification information may uniquely identify a vehicle on which it is mounted. For example, the identification information may include a unique identification number, an account number, or any other information that may be used to uniquely identify a vehicle.

The identification component 304 may be positioned to align with the receiver component 204 of the fuel distribution station 102 when the fuel receiving interface 302 is coupled to the distribution interface. The alignment of the identification component 304 with the receiver component 204 may allow electrical or electromagnetic communication between the identification component 304 and the receiver component 204. For example, the identification component 304 may include a passive, active, or battery assisted passive RFID tag that stores identification information. The RFID tag may be mounted on a vehicle inlet, such that an RFID tag reader in the outlet plug aligns with the RFID tag when the inlet and outlet plugs are coupled.

In one embodiment, the identification component 204 may be part of an inductive charging interface. For example, some inductive charging interfaces have an identifier that is communicated to the inductive charger before or during charging. This identifier may be used to uniquely identify the vehicle. In one embodiment, the identification component 204 may include a wireless dongle that plugs into a diagnostic port of the vehicle. For example, some vehicles include diagnostic ports to which mechanics can connect computers to diagnose problems with a vehicle. Wireless devices which plug into the diagnostic ports can be used to wirelessly send and receive diagnostic codes and data. In one embodiment, a vehicle identification number (VIN) may be communicated via the diagnostic port. Example dongles available on the market include the Delphi Connect® from Delphi Automotive®.® or the OBDLink® from OBDSolutions®.

In one embodiment, the identification component 204 may include a tag or visual indication on the vehicle which may be captured by a camera. For example, the identification component 204 may include a tag or license plate on a bumper of the vehicle, or at another location, that can be captured by a camera. The identification information may be extracted from an image of the vehicle and used to identify the vehicle.

In one embodiment, the identification component 304 may be electrically coupled to a conductor that is configured to make contact with an electrical conductor of the distribution interface. For example, the identification component 304 may be coupled to a spring-loaded conductor that contacts a conductor of the distribution interface or fuel receiving interface 302 to provide a communication pathway to provide the identification information to the receiver component 204. In one embodiment, conductors of the distribution interface or the fuel receiving interface 302 that are already used for purposes prescribed by a recharging standard may also be used to provide a communication pathway between the identification component 304 and the receiver component 204.

The identification component 304 may provide the identification information in response to a query from the receiver component 204. In one embodiment, the identification component 304 may require a valid passcode from the fuel distribution station 102 before providing the identification information.

In one embodiment, the identification component 304 may be permanently affixed to a vehicle. As used herein, the term “permanently affixed’ is given to mean that the identification component 304 is affixed or mounted on a vehicle in a manner that it is not removable in a functional state, requires a specialized key or tool for removal, and/or is only removable with damage to the vehicle. For example, the identification component 304 may not be removable from the vehicle while maintaining the identification component 304 of identification information in a functional state. In one embodiment, the identification component 304 is mounted on a vehicle inlet which is permanently affixed to the vehicle. The identification component 304 may not be removable because of how it is mounted, such as by using a strong and permanent adhesive, embedded in an object, or the like.

In one embodiment, the identification component 304 is not removable from the vehicle without damaging the identification component 304. For example, the identification component 304 may be securely glued, welded, or embedded within the vehicle, body of the vehicle, or portion of the vehicle so that it can only be removed with physical damage to the identification component 304 or the vehicle.

In one embodiment, the identification component 304 self-destructs in response to removal from the vehicle. For example, the identification component 304 may be configured to detect removal or attempted removal from the vehicle and the identification component 304 may self-destruct. In one embodiment, the identification component 304 self-destructs by electronically destroying the identification information. For example, a transitory or non-transitory memory may be erased. In another embodiment, the identification component 304 self-destructs by mechanically destroying the identification component 304. For example, if the identification component 304 includes a tag or chip, the tag or chip may be configured to be mechanically destroyed so that it no longer functions and/or that the memory of the tag or chip is damaged or erased.

According to one embodiment, the fuel distribution station 102 and the vehicle fueling interface 104 may provide significant benefits with regard to reduced costs and flexibility in ways that fueling services can be billed. In one embodiment, authentication and refueling may happen automatically. For example, because the receiver component 204 and the identification component 304 are aligned or are in electrical or electromagnetic communication, the user may only need to insert the distribution interface into the fuel receiving interface 302 to begin and accomplish fueling. No card swipes, number entry, signatures, or network server-based authentication may be needed to begin the fueling.

In another embodiment, “sharing” of authorization information or cards is prevented because the identification component cannot be moved to another vehicle and cannot be used to authorize fueling for another vehicle. For example, when the distribution interface and the fuel receiving interface 302 are coupled, the receiver component 204 is blocked from receiving identification information from any other vehicle or device. Similarly, the identification component 304 is also blocked from providing identification information to a different station or interface. If the distribution interface and the fuel receiving interface 302 are decoupled, or if the identification component 304 is removed, fueling may be stopped.

According to one embodiment, because sharing is prevented and because a specific car can be identified, a maximum potential cost for a subscription can be calculated. This allows for various subscription based services and payment that would otherwise not be possible. Furthermore, less infrastructure is needed because there may be no need for card readers, display screens, or the like.

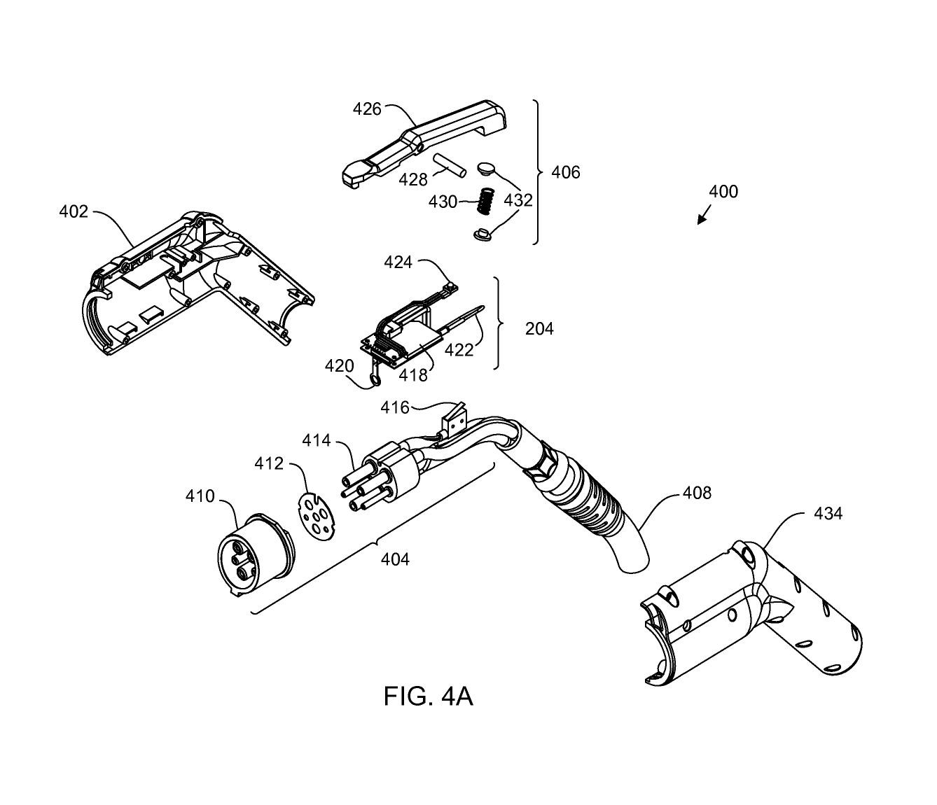

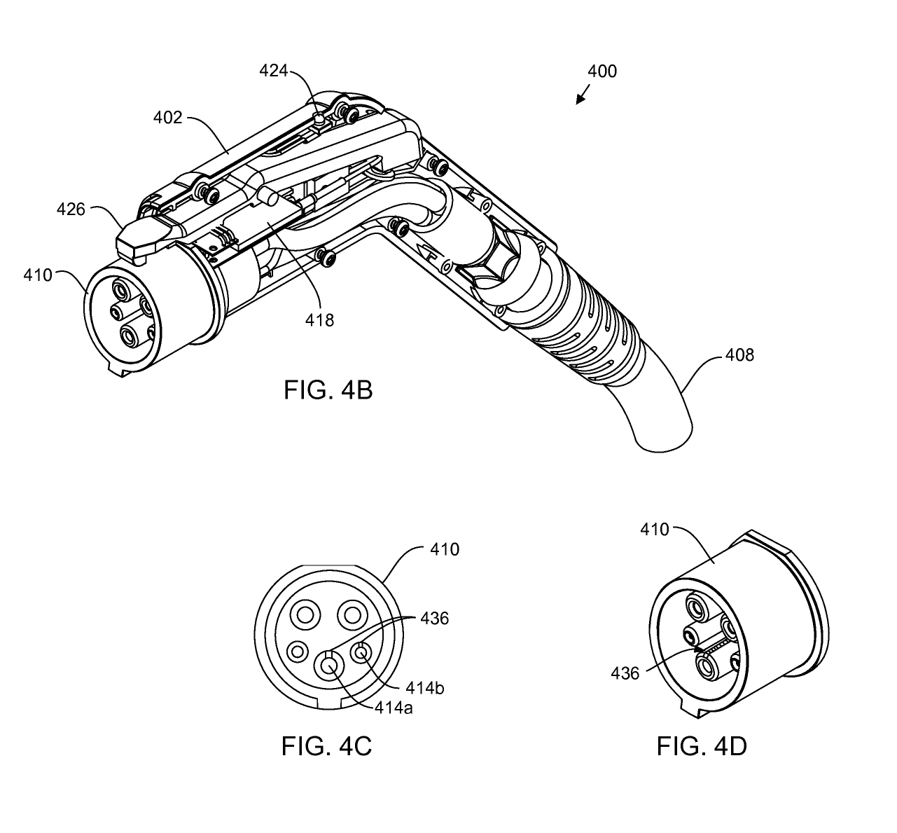

FIGS. 4A and 4B illustrate an outlet plug 400 of a fuel distribution station 102 that complies with an SAE J1772 standard. The outlet plug 400 includes a housing formed by a right handle cover 402 and a left handle cover 434. The outlet plug 400 also includes a power distribution interface 404, a receiver component 204, and a latch assembly 406, and may be connected to a body of a fuel distribution station 102 by a power cable 408. FIG. 4A illustrates the outlet plug 400 in an exploded view with various parts of the outlet plug 400 unassembled. FIG. 4B illustrates the outlet plug 400 in an assembled view with the left handle cover 434 omitted for internal viewing of the outlet plug 400. Although the embodiment of FIGS. 4A and 4B illustrates a recharging outlet plug, one of skill in the art will recognize that the scope of the present disclosure encompasses a fuel pump handle or other refueling handle or any other interface for refueling a vehicle.

The power distribution interface 404 includes a plug tip 410, a rubber gasket 412, male conductors 414, and a safety switch 416. In one embodiment, some of the male conductors 414 are used to provide power to recharge a vehicle, while others of the male conductors 414 are used to communicate with a charging system of a vehicle, receive identification information for the vehicle, and/or detect a proximity of a vehicle inlet. The safety switch 416 may be used to break an electrical or communication connection to a vehicle and/or enable an authorization process.

The receiver component 204 includes a receiver board 418 that is connected to an antenna 420 and a light emitting diode (LED) 424. The receiver board 418 may include circuitry for querying and/or receiving identification information from a vehicle via the antenna 420. The circuitry of the receiver board 418 may also include circuitry for controlling the LED 424. The LED 424 may include a single color or multi-color LED which may be used to indicate an authorization status, a charging status, or other status of a connected vehicle or fuel distribution station 102. The receiver component 204 is also connected to one or more communication lines 422 which may be used to communicate with an authorization component 206 or other components of a fuel distribution station 102.

The latch assembly 406 may be used to selectively secure the outlet plug 400 to an inlet of a vehicle. The latch assembly 406 may also be configured to depress the switch 416 each time the latch 426 is pressed and/or each time the outlet plug 400 is coupled or decoupled from a vehicle. The latch assembly 406 includes a latch 426, a dowel pin 428, a spring 430, and spring mounts 432.

According to one embodiment, in the assembled state as depicted in FIG. 4B, the antenna 420 resides between the male conductors 414. This location may match a location of an identification component 304 of a vehicle inlet.

The outlet plug 400 is given by way of example only. For example, the antenna 420 may be omitted in cases where wireless communication with an identification component 304 is not used. In some embodiments, wired communication between a receiver component 204 and an identification component 304 may be established over a wired connection, a wireless connection, or both. If a wired communication is used, a receiver component 204 may be located in the outlet plug 400 or may be located in the body of a fuel distribution station 102 or elsewhere. In one embodiment, the outlet plug 400 may be modified from that depicted in FIGS. 4A and 4B in order to provide a wired connection between an identification component 304 and a receiver component 204. In one embodiment, for example, the receiver component 204 may be electrically connected with a conductor 414 and the plug tip 410 may include notches such that a tag, chip, or other identification component 304 can be in electrical contact with one or more of the conductors 414. Thus, wired electrical communication between a receiver component 204 and an identification component 304 may be established via one of the conductors 414 or other conductor.

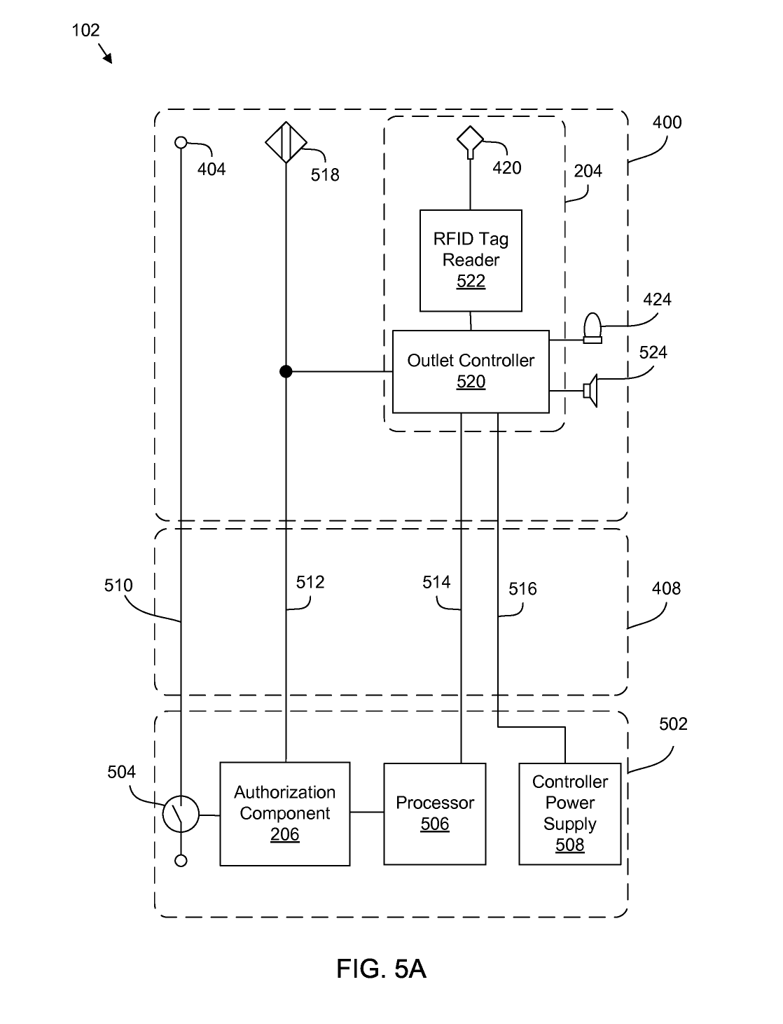

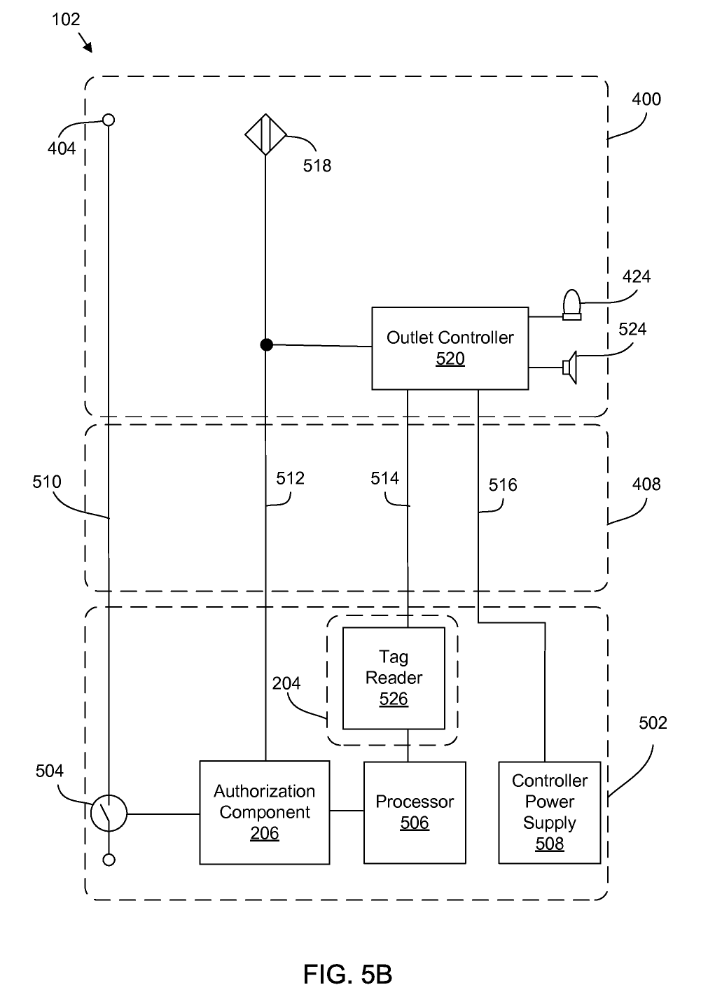

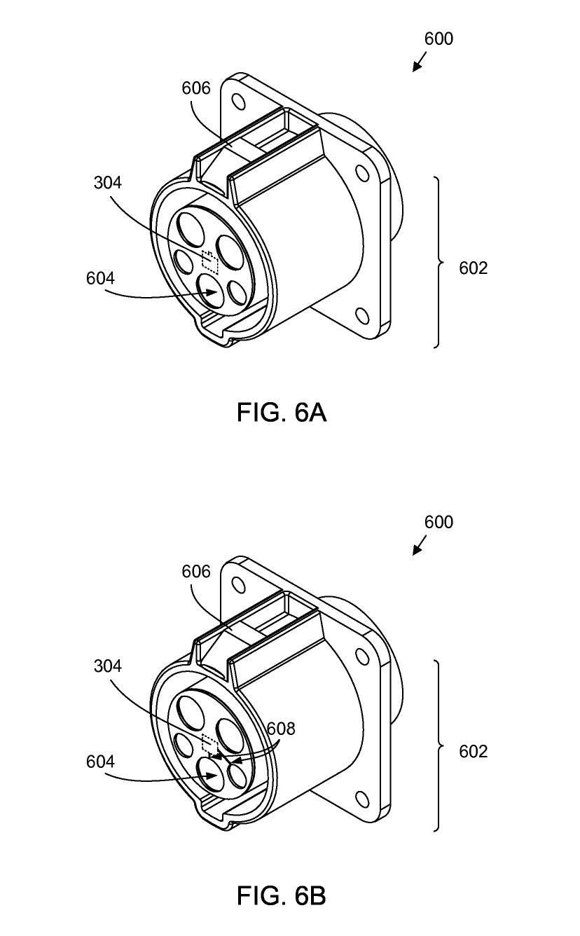

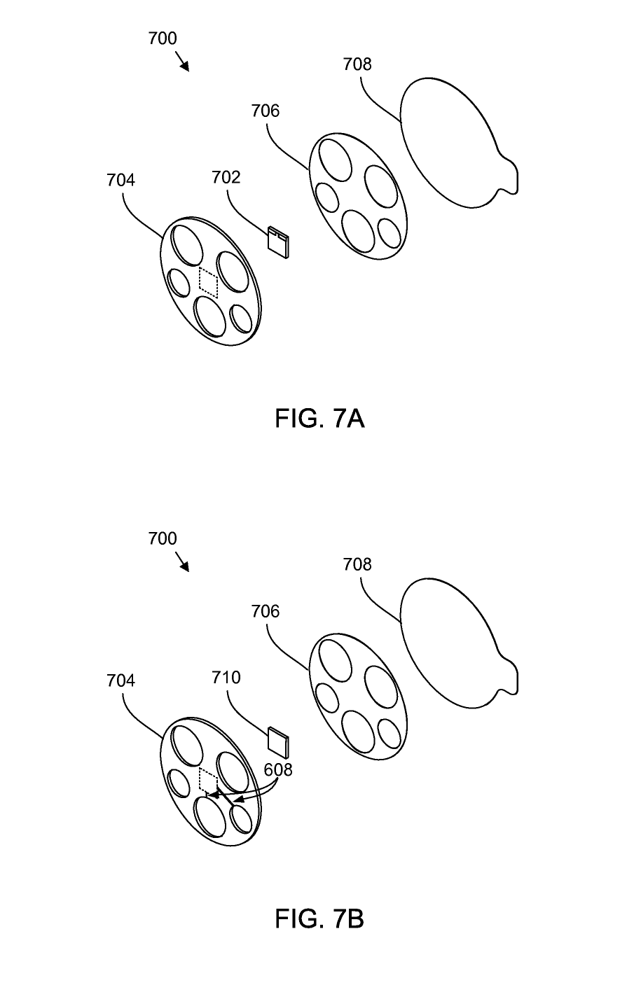

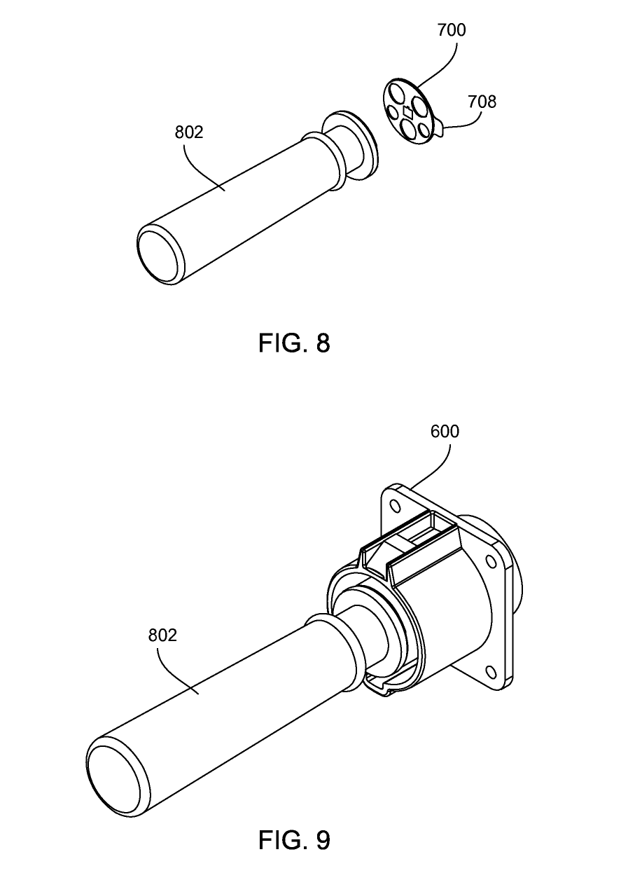

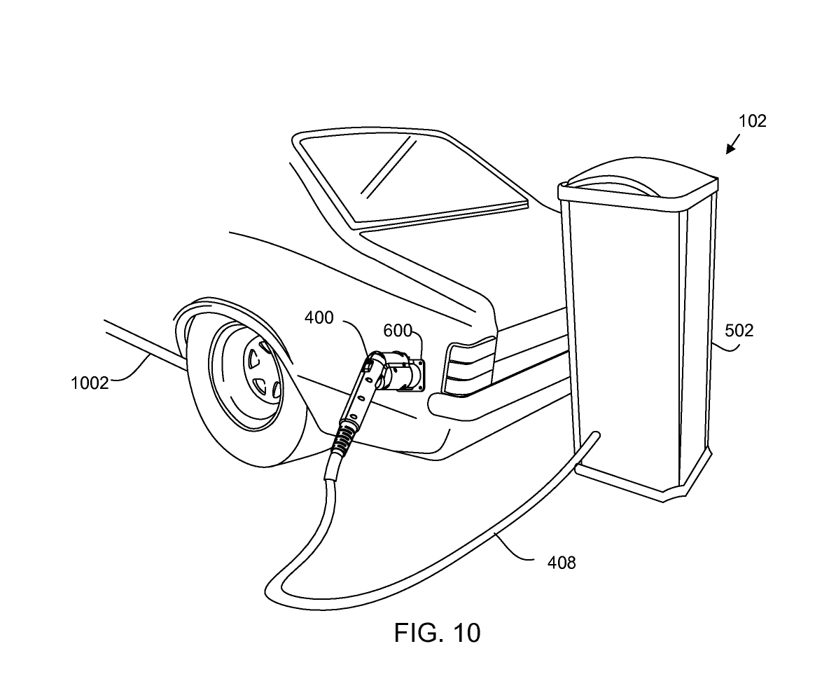

FIGS. 4C and 4D illustrate one embodiment of a plug tip 410 with notches 436 for allowing an identification component 304 mounted in a vehicle inlet (e.g., see FIGS. 6B and 7B) to create an electrical connection to a ground conductor 414a and a proximity conductor 414b. The notches 436 are illustrated facing the interior of the plug tip 410, but may be located in any position needed to create electrical contact with a trace, contact, or spring actuated contact on a vehicle fueling interface 104, an adapter, or other contact in communication with an identification component 304 of the fueling interface 104. The notches 436 include gaps in insulation surrounding a conductor 414 so that a contact, trace, or other electrical conductor connected to a chip or tag in a vehicle fueling interface 104 may create physical electrical contact with the proximity conductor 414b and/or the ground conductor 414a. In one embodiment, the notches 414 may be filled with a conductive material to provide conduction through the plug tip 410. In one embodiment, a spring actuated conductor may be placed within a notch 436 to facilitate contact between the proximity conductor 414b and the ground conductor 414a. Further discussion regarding physical conductive communication between the conductors 414 and a tag, chip, or other identification component 304 will be provided in relation to FIGS. 5B, 6B, and 7B.

FIG. 5A is a schematic diagram showing one embodiment of electrical interconnection between portions of a fuel distribution station 102. In the embodiment depicted in FIGS. 5A and 5B some components of a site controller 110 are integrated as part of a fueling station. In alternate embodiments, the site controller 110 and its components may be separate or housed in separate housing from the refueling station. The T electrical interconnection in FIG. 5A may correspond to an embodiment that uses an RFID tag reader or other wireless communication device to receive identification information from a tag, chip, or other identification component of a vehicle fueling interface 104 or vehicle. The fuel distribution station 102, as depicted, includes a station housing 502, a power cable 408, and an outlet plug 400. The station housing 502 includes a flow component 504, an authorization component 206, a processor 506, and a controller power supply 508. The power cable 408 includes a power distribution line 510, a proximity detect line 512, a communication line 514, and a power supply line 516. The lines 510, 512, 514, and 516 may include more than one conductive line. For example, the communication line 514 may include two or more wires for communication between components, and the power supply line 516 may include two or more conductors to provide electrical energy. In one embodiment, the power distribution line 510 may be replaced by a carrier tube for a liquid or gaseous fuel. The outlet plug 400 includes a power distribution interface 404, a proximity detector 518, and a receiver component 204. The receiver component 204 includes an outlet controller 520, an RFID tag reader 522, and an antenna 420. The receiver component 204 is also connected to an LED 424 and a speaker 524.

The authorization component 206 receives input from the proximity detector 518 via the proximity line 512 and from the processor 506. The authorization component 206 controls a flow component 504 that includes a switch for selectively allowing the flow of electricity to the power distribution interface 404. The processor 506 receives identification information from the receiver component 502 via the communication line 514 and may process and/or provide that identification information to the authorization component 206. The controller power supply 508 provides power to the receiver component 204 via the power supply line 516.

The outlet controller 520 receives an indication of proximity from the proximity detector 518 and identification information via the antenna 420 and RFID tag reader 522. The outlet controller 520 may provide data to and/or receive data from the processor 506. For example, the authorization component 206 may determine whether a vehicle is authorized and provide an indication of authorization or rejection via the processor 506 and communication line 514. The communication line 514 may include any type of communication line that includes one or multiple conductors or lines. For example, a coaxial cable, twisted pair cable, or other cables may be used.

The outlet controller 520 may control a state and/or color of the LED 424. In one embodiment, the outlet controller 520 turns the LED 424 off when the fuel distribution station 502 does not sense a connected vehicle. The outlet controller 520 may turn the LED 424 on in a solid green when a vehicle is being recharged. If a vehicle is connected but no identification information was received, the outlet controller 520 may cause the LED 424 to blink red. If a vehicle is connected and identification information is detected but not valid, the outlet controller 520 may cause the LED 424 to alternately blink red and then blink green. If the vehicle is disconnected, the outlet controller 520 may turn off the LED 424.

The outlet controller 520 may play sounds via the speaker 524 that indicate a charging status, an authorization status, a warning, or other information regarding the fuel distribution station 102 or an attached vehicle.

FIG. 5B is a schematic diagram showing another embodiment of an electrical interconnection between portions of a fuel distribution station 102. For example, the electrical interconnection in FIG. 5B may correspond to an embodiment that uses a tag reader 526 or other communication device to receive identification information from a tag, chip, or other identification component over a wired connection. The fuel distribution station 102, as depicted, includes a station housing 502, a power cable 408, and an outlet plug 400. The station housing includes a flow component 504, an authorization component 206, a processor 506, a controller power supply 508, and a receiver component 204. The receiver component 204 is illustrated in the station housing but may be located elsewhere, such as within the outlet plug 400. The receiver component 205 includes a tag reader 526. The tag reader 526 may be configured to read identification information from a tag, chip, or other identification component over a wired connection. The tag reader may include a 1-Wire™ tag reader manufactured by Maxim® or other similar reader or programmable device. The tag may include a 1-Wire™ tag, such as a 1-Wire™ EEPROM, such as the DS28E22 DeepCover Secure Authenticator available through Maxim®.

The power cable 408 includes a power distribution line 510, a proximity detect line 512, a communication line 514, and a power supply line 516. The lines 510, 512, 514, and 516 may each include more than one conductive line. For example, the communication line 514 may include two or more wires for communication between components and the power supply line 516 may include a pair of hot power supply conductors to provide electrical energy (e.g., two or more of conductors 414 of FIG. 4A). In one embodiment, the power distribution line 510 may be replaced by a carrier tube for a liquid or gaseous fuel.

The outlet plug 400 includes a power distribution interface 404, a proximity detector 518, and an outlet controller 520. The proximity detector 518 may include a conductor or sensor that senses a proximity of a vehicle fueling interface 104. For example, the proximity detector may be a capacitive or inductive detector that detects a voltage or current in a nearby vehicle fueling interface 104. In another embodiment, the proximity detector 518 may include an electrical contact that contacts a conductor of the vehicle fueling interface 104 when the outlet plug 400 is coupled to the vehicle fueling interface 104. For example, when a voltage or current is sensed through the proximity detect line 512, this may signal that the outlet plug 400 is coupled to an inlet of the vehicle. The outlet controller 520 is connected to and controls an LED 424 and speaker 524.

The authorization component 206 receives input from the proximity detector 518 via the proximity line 512 and input from the processor 506. The authorization component 206 controls a flow component 504 that includes a switch for selectively allowing the flow of electricity to the power distribution interface 404. The processor 506 receives identification information from the receiver component 204 and may process and/or provide that identification information to the authorization component 206. The controller power supply 508 provides power to the receiver component 204 via the power supply line 516.

The tag reader 526 receives identification information from an identification component over the proximity line 512 (e.g., via the authorization component 206 or the outlet controller 520). For example, the proximity line 512 may be electrically coupled with an identification component 304, such as a 1-Wire™ chip manufactured by Maxim® or other similar chip or programmable device that stores identification information. The tag reader 526 provides the information to the processor 506 and/or the outlet controller 520. Thus, the fuel distribution station 102 may receive the identification information over a wired connection using the proximity line 512 and/or a ground line.

For example, the authorization component 206 may determine whether a vehicle is authorized and provide an indication of authorization or rejection via the processor 506, tag reader 526, and communication line 514. The communication line 514 may include any type of communication line that includes multiple conductors or lines. For example, a coaxial cable, twisted pair cable, or other cables may be used.

FIG. 6A is a perspective view of a vehicle inlet 600. The vehicle inlet 600 is one embodiment of a fuel receiving interface 302 that includes an identification component 304. The vehicle inlet 600 includes an inlet body 602, female conductors within recesses 604, at least a portion of an identification component 304, and a latch ridge 606.

The inlet body 602 and the recesses 604, in the depicted embodiment, are configured to mate with the power distribution interface 404 of FIGS. 4A and 4B. For example, the recesses 604 may be shaped to receive the male conductors 414 to allow female conductors to electrically couple with the male conductors 414. The latch ridge 606 is positioned and shaped to engage the latch 426 to retain the plug outlet 400 to the vehicle inlet 600.

In one embodiment, the identification component 304 includes an RFID tag embedded near a surface of the vehicle inlet 600. When the inlet body 602 and the outlet plug 400 are coupled, the RFID tag is positioned to align with the antenna 420 of FIGS. 4A and 4B. The RFID tag and the antenna 420 may then be in electrical communication so that identification information can be passed from the RFID tag to the fuel distribution station 102. In one embodiment, the identification component 304 of the vehicle inlet 600 may be configured at manufacture to hold an RFID tag or other identification component 304. In other embodiments, an RFID tag or other identification component 304 may be mounted on the vehicle inlet 600 after manufacture or even on a vehicle inlet of a vehicle. For example, an aftermarket mounting of an identification component 304 may be performed on any vehicle fueling interface 104. In one embodiment, an identification component 304 configured to communicate over a wired connection may be in electrical communication with female conductors within recesses 604. Thus, wired electrical communication may be established between the identification component 304 and a receiver component 204 connected to one of the conductors 414 of FIG. 4A.

FIG. 6B is a perspective view of another embodiment of a vehicle inlet 600. The vehicle inlet 600 may be similar to the vehicle inlet 600 of FIG. 6A but also includes conductors 608 which provide electrical communication between the identification component 304 and a conductor 414 of the outlet plug 400 when the outlet plug 400 is coupled to the vehicle inlet 600. In one embodiment, the conductors 608 may contact a conductor in a notch 436 of the outlet plug 400 to allow a chip, tag, or other identification component 304 configured to communicate over a wired interface to communicate with a receiver component 204 of a fuel distribution station 102. In one embodiment, the conductors 608 may include traces, electrical contacts, and/or spring activated contacts to create an electrical contact with a notch 436 of the outlet plug 400.

FIG. 7A illustrates a bezel assembly 700 for mounting an RFID tag 702 on a vehicle inlet 600. In one embodiment, the bezel assembly 700 may be used to perform an aftermarket mounting of an RFID tag 702 or other identification component 204 on a vehicle with an SAE J1772 compliant vehicle inlet. The bezel assembly 700 includes a tag bezel 704, an adhesive layer 706, and a removable backing 708. The tag bezel 704 is configured to receive the RFID tag 702. The adhesive layer 706 is configured to securely mount the tag bezel 704 and the RFID tag 702. In one embodiment, the adhesive layer 706 comprises a pressure sensitive adhesive that is activated when pressure is applied. The removable backing 708 protects the adhesive layer 706 until the bezel assembly 700 is ready for mounting.

In one embodiment, the tag bezel 704 may also include an antenna to allow the RFID tag 702 to communicate with an RFID tag reader. In another embodiment, the RFID tag 702 may be located elsewhere and electrically connected to the antenna positioned proximally to the receiver component 204.

FIG. 7B illustrates a bezel assembly 700 with a tag 710 that is configured to communicate over a wired interface and conductors 608 for providing an electrical connection with conductors 414 of an outlet plug 400 or female conductors in recesses 604 of a vehicle inlet 600.

FIGS. 8 and 9 illustrate mounting of the tag bezel assembly 700 on a vehicle inlet 600. In FIG. 8 the bezel assembly 700 (e.g., the bezel assembly 700 of FIG. 7A or 7B) and an applicator 802 are shown. The applicator 802 allows a user to provide pressure to the bezel assembly 700 to secure a tag and bezel assembly to a vehicle inlet. The removable backing 708 is removed before application and the bezel assembly 700 is applied to a vehicle inlet with force. FIG. 9 illustrates the applicator 802 as force is applied to the vehicle inlet 600 to secure the bezel assembly 700 to the vehicle inlet 600.

The applicator 802 may be used to apply a tag bezel assembly 700 with a tag that is configured to communicate wirelessly or over a wired interface. Furthermore, although the applicator 802 is illustrated in conjunction with a J1772 vehicle inlet 600, any type of vehicle inlet is contemplated within the scope of the present disclosure. For example, electrical inlets for different types of vehicles may utilize different standards and have different shapes or configurations. In one embodiment, a tag or tag bezel assembly may be mounted on an interface for a Tesla® vehicle which includes male conductors rather than female receptacles. In one embodiment, a tag for wired communication (such as a 1-Wire™ chip manufactured by Maxim®) may be mounted between a ground conductor and a proximity conductor. The tag may be able to communicate over the proximity conductor and/or ground conductor with a vehicle fueling station to provide identification information to identify the vehicle.

In one embodiment, using a wired connection may provide for more secure and/or more successful communication of identification information from the vehicle to the fuel distribution station 102. For example, because different vehicles may have vehicle inlets complying with different standards, one or more adapters may be needed between the vehicle inlet and the outlet plug 400. If an RFID tag is used, there may be less likelihood that a tag reader can receive identification information from the RFID tag due to the intervening adapters. However, if the identification information is provided over a proximity line, ground line, or other line used to provide power or communication between the fuel distribution station and the vehicle, then the adapters will carry this information as well.

In one embodiment, a distribution interface complying with one recharging standard may be used to recharge a vehicle having a fuel receiving interface 302 complying with a different recharging standard. For example, an outlet plug 400 complying with an SAE J1772 standard may be used to recharge a Tesla® vehicle having a proprietary Tesla® vehicle inlet. Because a Tesla® vehicle inlet has a different physical configuration from, but uses the same communication protocol as, the SAE J1772 standard, a physical adapter may be used to couple the Tesla® vehicle inlet to a SAE J1772 outlet plug. Because the adapter may block wireless communication between an RFID tag and an RFID tag reader, wired electrical communication between an identification component 304 on the vehicle with the Tesla® vehicle inlet and a receiver component 204 of a fuel distribution station 102 may be needed. In one embodiment, a chip or tag may be mounted to the Tesla® vehicle inlet and electrical communication between a conductor of the Tesla® vehicle inlet and the chip or tag may be created (e.g., using a wire, trace, or other conductor). A tag reader (or other receiver component 204) of the fuel distribution station 102 may be electrically connected to a conductor or line that corresponds to the conductor to which the chip or tag of the Tesla® vehicle inlet was connected. Thus, even if an adapter is used to couple a distribution interface to a fuel receiving interface 302, communication between a receiver component 204 and an identification component 304 may be established.

FIG. 10 is a perspective view of a vehicle 1002 plugged into a fuel distribution station 102. The fuel distribution station 102 is shown including a station housing 502, a power cable 408, and an outlet plug 400. The power cable 408 extends from the station housing 502 and includes the outlet plug 400. The outlet plug 400 is coupled to a vehicle inlet 600.

The systems, methods, and apparatuses discussed above enable vehicle-based subscription refueling services. For example, because a specific vehicle can be securely identified, subscriptions corresponding to the vehicle for unlimited refueling within a specific time period may be sold. This is because a maximum service and/or refueling usage for the vehicle can be calculated. This is similar to how subscription communication services are often tied to a specific device or phone.

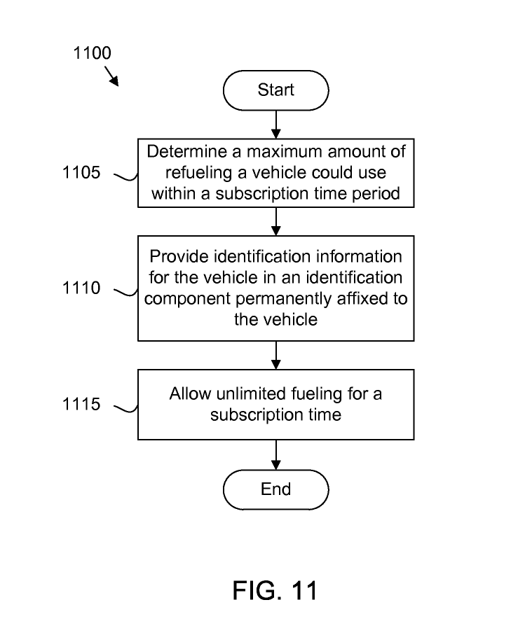

FIG. 11 is a schematic block diagram illustrating a method 1100 for providing a refueling subscription.

The method 1100 begins and a maximum amount for refueling a vehicle is determined 1105. For example, a maximum amount of fuel that a vehicle can consume in a month can be calculated based on the efficiency of the vehicle, how long it takes to use a given amount of fuel or energy, and/or how long it takes to refuel a vehicle.

An example of calculating a maximum amount of fuel usage for an electric vehicle will now be discussed. Specifically, assume that a specific electric vehicle is capable of 11 kilowatt hours (KWH) of energy storage, has a 3 kilowatt (KW) charge rate, and has a 12 KWH/hour usage rate. If this vehicle has a minimum interval of four hours between charges, the maximum percentage of time that the vehicle could be charged is:

(11 KWH reserve/3 KW rate of charge)/(11 KWH/12 KW rate of discharge+11 KWH/3 KW rate of charge+4)=(3.6667)/(8.58333)=43%

So the vehicle, at a maximum, could be charged during 43% of a subscription period. For a one-month period, the maximum hours would be:

43%*24*30=310 hours

Thus, a provider can know that absolute maximum cost will be 310 hours of recharging, as long as the recharging is restricted to the specific vehicle. Comparatively, if authorization information could be shared across multiple vehicles and/or by multiple people, that maximum amount of charging is much higher and may not even be possible to determine. This is partly because there are no necessary gaps between refueling, as there would be if only one car is allowed to be refueled under a subscription. As an example, assuming a zero interval between charges and no requirement for discharge, because the information may be shared, we see potential non-overlapping usage of (11 KWH/3 KW)/(0 rate of discharge+11 KWH/3 KWH+0interval delay)=100%, assuming the identification information can only be used with one device at a time. If overlapping is possible (i.e., multiple vehicles recharging at same time) this could be even higher. Thus, securely limiting refueling or recharging to a specific vehicle allows for a significantly reduced and/or actually calculable maximum.

According to one embodiment, determining 1105 the maximum amount can be done in the manner discussed above, or may be looked up in a database of fuel usage information for various cars. For example, a data profile for a vehicle type may be stored and accessed to determine 1105 the maximum amount that a vehicle can be refueled.

The method 1100 continues and identification information is provided 1110 for the vehicle. The identification information may be provided 1110 by programming an already mounted identification component 304, swapping an identification component 304, and/or mounting a new identification component 304. According to one embodiment, a new subscriber will need an RFID tag 702 or other identification component 304 mounted as illustrated in FIGS. 8 and 9. As discussed above, the identification information may be securely stored within an identification component 304 which cannot be used to fuel other vehicles.

The method 1100 also includes allowing 1115 unlimited fueling at a fuel distribution station 102 for the subscription time period. For example, a user may be able to refuel a vehicle without paying for each refueling and/or without any tracking of the refueling. For example, the individual will not need to pay any extra money for refueling as the vehicle has a corresponding unlimited subscription. In one embodiment, the recharging of the vehicle will be allowed 1115 in response to the fuel distribution station 102 receiving the identification information. For example, the fueling of the vehicle may be allowed 1115 based on identification information corresponding to a current subscription listed in an authorization list maintained by the fuel distribution station 102.

In addition, the method 1100 may also include updating an authorization list at the fuel distribution station 102. This may include deleting information corresponding to accounts or subscriptions that have expired as well as adding information corresponding to new accounts or subscriptions. In one embodiment, the authorization list may only be updated on a period greater than or equal to about one hour. In another embodiment, the authorization list may only be updated on a period greater than or equal to about one day. In another embodiment, the authorization list may only be updated on a period greater than or equal to about one week.

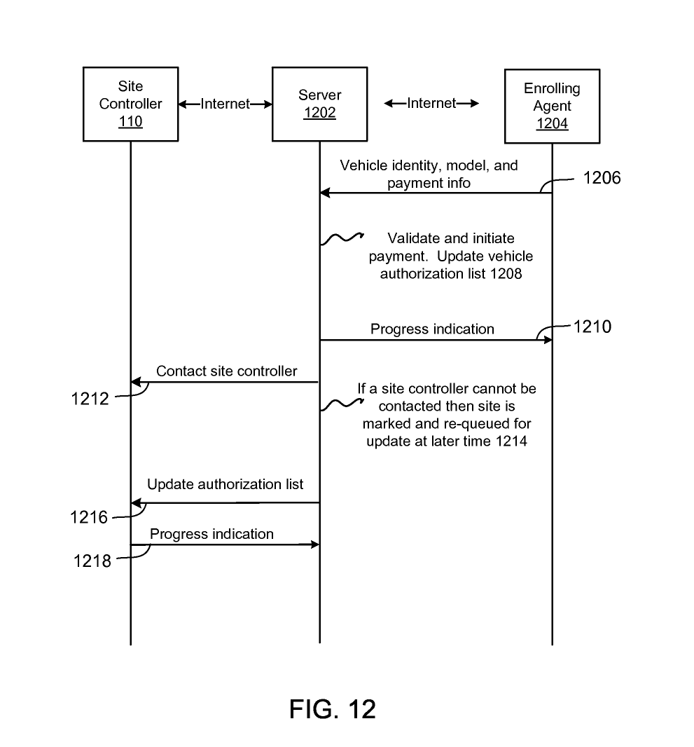

FIG. 12 is a schematic diagram illustrating a communication flow for managing a list of preauthorized vehicles. The flow includes operations and communication between a site controller 110, a server 1202, and an enrolling agent 1204. In one embodiment, the site controller 110 may include the site controller of either FIG. 1 or FIG. 2. The server 1202 may include the subscription management server 106 of FIG. 1. The enrolling agent 1204 may include a computing device, such as the computing device 118 of FIG. 1. In one embodiment, the enrolling agent 1204 may include a smartphone used to access a website hosted by the subscription management server 106. The site controller 110, server 1202, and/or enrolling agent 1204 may be in communication with each other via a network, such as the Internet.

At 1206, the enrolling agent 1204 sends information about a vehicle and payment information. The information about the vehicle may include the vehicle make and model, an identifier uniquely identifying the vehicle, and/or the like. The information about the vehicle includes information sufficient to uniquely identify the vehicle in relation to other vehicles. In one embodiment, the information about the vehicle may include identification information which will be used by the site controller 110 to uniquely identify the vehicle. In one embodiment, the vehicle identification information may be assigned to the vehicle in response to receiving the vehicle identity, model, and payment information. The payment information may include any type of payment details such as payment card information, account information, or a record of payment.

At 1208, the server 1202 validates or initiates payment based on the received payment information. If payment is successfully processed and/or validated, the server 1202 updates a list of preauthorized vehicles to include an entry corresponding to the vehicle. In one embodiment, the server 1202 maintains a list that includes only those vehicles that are authorized to use fueling stations. For example, entries for vehicles without current subscriptions may be removed.

At 1210, the sever 1202 provides a progress indication to the enrolling agent 1204 indicating whether the vehicle is now authorized for refueling. At 1212, the server 1202 contacts one or more site controllers 110. At 1214, if the site controller 110 is not available, the server 1202 may mark the site and re-queue for a later update. For example, if a connection with the site controller 110 is down or not available, the server 1202 will wait until later to provide the updated list. If the site controller 110 is available, the server 1202 provides an update to the site controller 110 at 1216. The update may include a completely updated list with all entries as determined by the server 1202. For example, each site controller 110 may store a complete list of preauthorized vehicles. In one embodiment, the site controller 110 may store a complete list of preauthorized vehicles for a specific area. At 1218, the site controller 110 may send a progress indication to notify the server 1202 regarding the success of the update.

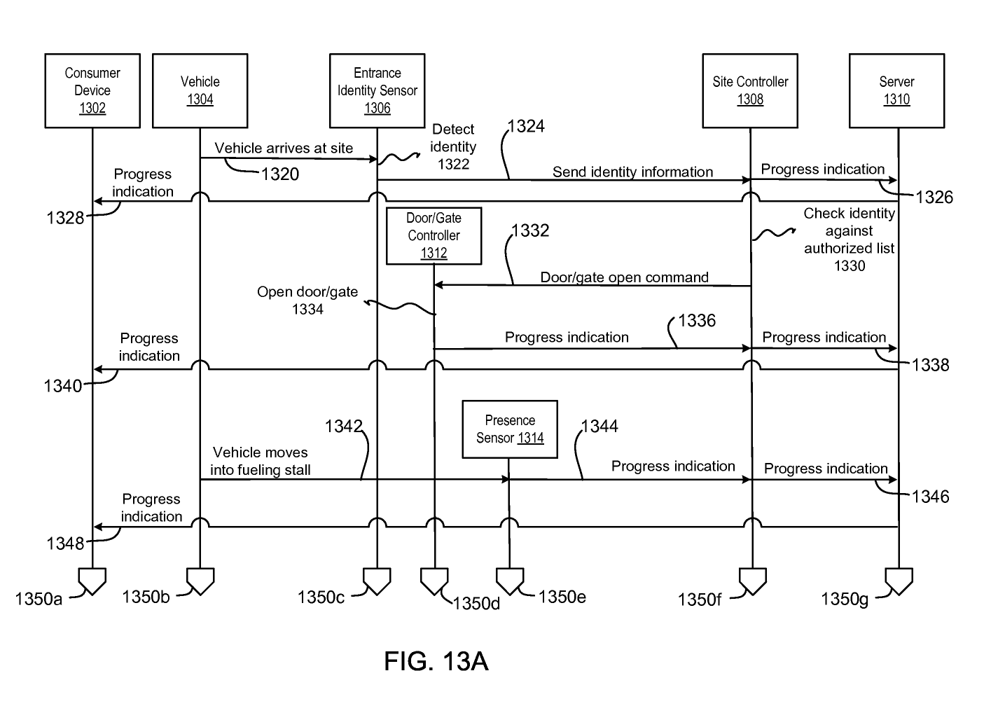

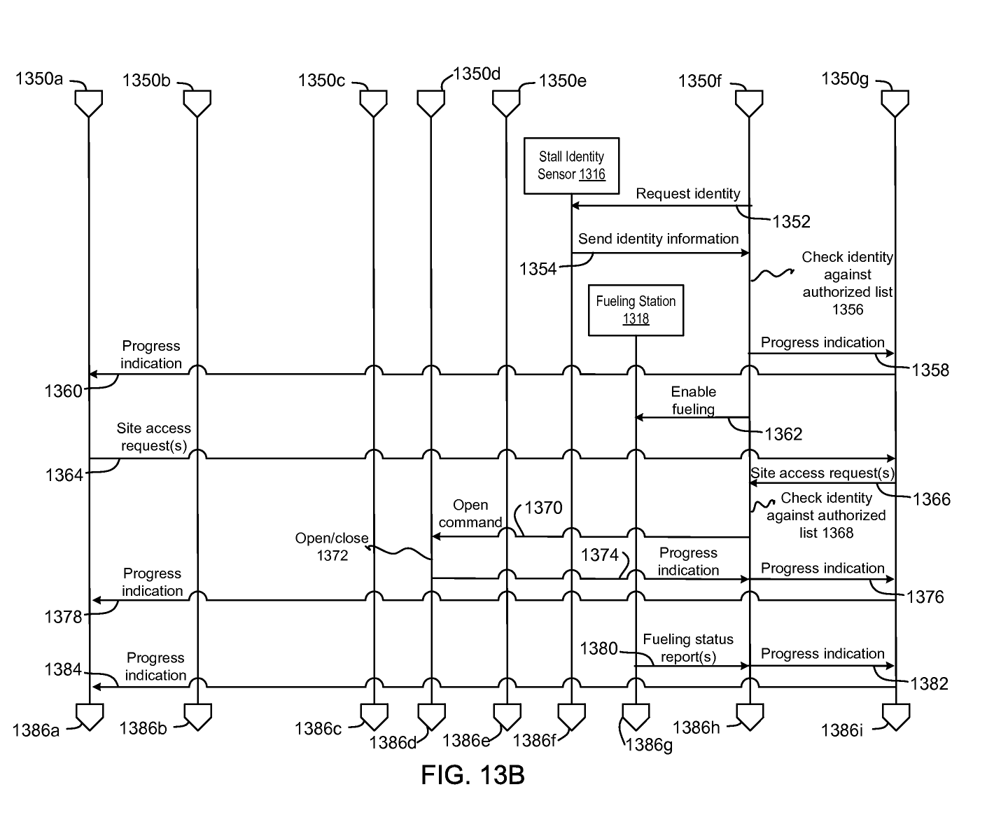

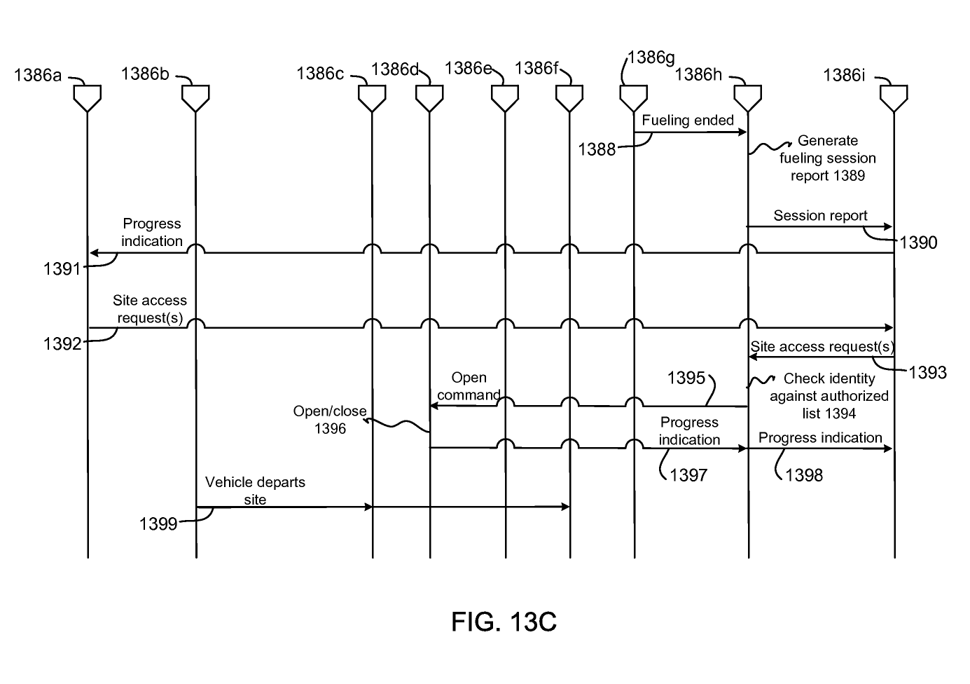

Turning now to FIGS. 13A, 13B, and 13C, an example communication and processing flow for the system 100 of FIG. 1 is illustrated. At 1320, a vehicle 1304 arrives at a fueling site. At 1322, an entrance identity sensor 1306 detects and identifies the vehicle 1304. At 1324, the entrance identity sensor 1306 sends identity information to a site controller 1308. At 1326, the site controller 1308 sends a progress indication indicating the arrival of the vehicle 1304 at the corresponding site to the server 1310. At 1328, the server 1310 sends a progress indication to a consumer device 1302 indicating arrival of the vehicle 1304 at the refueling site. The consumer device 1302 may include a device associated with the vehicle 1304, such as a smartphone or other computing device of an owner of the vehicle 1304.

At 1330, the site controller 1308 checks the identification information against a locally maintained list of preauthorized vehicles to determine whether the vehicle 1304 is authorized to use a fueling station. At 1332, if the vehicle 1304 is authorized, the site controller 1308 sends a door/gate open command to the door/gate controller 1312. At 1334, the door/gate controller 1312 opens the door or gate. At 1336, 1338, and 1340 progress indications are sent to notify the site controller 1308, server 1310, and consumer device 1302 of the opening of the door or gate. At 1342, the vehicle 1304 moves into a fueling stall and is detected by a presence sensor 1314. At 1344, 1346, and 1348, progress indications are sent to notify the site controller 1308, server 1310, and consumer device 1302 of the presence of the vehicle 1304 in the fueling stall (or parking spot, etc.).

Continuing onto FIG. 13B, at 1352, the site controller 1308 sends a request for identity to a stall identity sensor 1316. At 1354, the stall identity sensor 1316 sends the identity information (identification information or other information from which the identification information can be determined) to the site controller 1308. At 1356, the site controller 1308 checks the identification information against a locally maintained list of preauthorized vehicles to determine whether the vehicle 1304 is authorized to refuel. At 1358 and 1360, progress indications are sent to indicate whether the vehicle 1304 is authorized for fueling. At 1362, if the vehicle 1304 is authorized, the site controller 1308 enables fueling at a corresponding fueling station 1318.

At 1364, while refueling (e.g., recharging) the consumer device 1302 sends one or more site access requests to the server 1310. For example, a user may wish to access the site to check on or take the vehicle 1304. At 1366, the server 1310 sends the site access request(s) to the site controller 1308. At 1368, the site controller 1308 checks the identity in the site access request(s). At 1370, if the request is authorized, the site controller sends an open command. At 1372, the door/gate controller 1312 opens and closes the door or gate, as needed. At 1374, 1376, and 1378, progress indications are sent indicating that the site was accessed. At 1380, the fueling station 1318 sends one or more fueling status reports to the site controller 1310. The fueling status reports may indicate a progress for refueling, an amount of refueling provided, an amount of time remaining, or the like. At 1382 and 1384, progress indications are sent including at least some of the information from the fueling status reports.

Continuing onto FIG. 13C, at 1388, fueling of the vehicle 1304 ends and the fueling station 1318 indicates the end of the fueling session to the site controller 1310. At 1389, the site controller 1310 generates a fueling session report. The fueling session report may include an amount of energy provided, an amount of time during which a stall was occupied, etc. At 1390, the site controller 1310 sends the session report to the server 1310. At 1391, the server 1310 sends a progress indication indicating that the vehicle 1304 is refueled and may include one or more details from the session report.

At 1392, the consumer device 1302 sends one or more site access requests to the server 1310. For example, a user may wish to access the site to check on or take the vehicle 1304. At 1393, the server 1310 sends the site access request(s) to the site controller 1308. Alternatively, in one embodiment, the site access request may be sent from the consumer device 1302 directly to the site controller 1308, such as via a wireless LAN, a Bluetooth port, or the like. At 1394, the site controller 1308 checks an identity in the site access request(s). At 1395, if the request is authorized, the site controller 1308 sends an open command. At 1396, the door/gate controller 1312 opens and closes the door or gate, as needed. At 1397 and 1398, progress indications are sent indicating that the site was accessed. At 1399, the vehicle 1304 departs the site, which is detected by the presence sensor 1314 and the entrance identity sensor 1306.

The flow of FIGS. 13A-13C is given by way of example only. In one embodiment, all communications between the site controller 1308 and the server 1310 may be omitted and/or delayed. For example, the flow may continue to work even if a current Internet or network connection between the site controller 1308 and the server 1310 is not maintained or is experiencing errors. In one embodiment, all messages may be saved up until a later time when the connection is reestablished.

In the example embodiment of FIGS. 13A-13C a vehicle is already registered or preauthorized. In some situations, a vehicle that is not yet preauthorized may arrive and may already have a detectable identifier. For example, the vehicle may already have an installed tag even if it has not yet been registered with the system. In one embodiment, the system may capture the identification information (vehicle tag number) and place the information into the central database. For example, the tag may be identified as new. As soon as payment is received, the tag may be added to a list of preauthorized vehicles. In one embodiment, a customer may sign up for service via a web app or web page and enter appropriate contact, vehicle information, and payment information via a web server. The received information may be processed for payment and then placed within a preauthorization list.

In one embodiment, a customer or service agent may enter a tag ID number or other identification information into a web page or application as well as the vehicle information into the database. If the identification information matches an entry in the database and the customer information is in the database a link is made between the identification information and the customer. A single customer may have multiple vehicles and multiple tags but only one tag per vehicle.

When a match is made the tag is consider “Valid” and set in the database as such. Periodically a list of new valid tags is transmitted to every station and added by the local site controller to its list of valid tags. On a regular basis according to business rules the customer information and payment details are evaluated and processed for payment based on the payment information in the database. Entries for vehicles associated with payment attempts that fail are marked as “Invalid.””. Periodically a list of new invalid tags is transmitted to every station, and these invalids tags are removed from the list of valid tags.

In one embodiment, a customer may arrive at a fueling station location with a tag on their vehicle. The tag is read and the identification information is compared to the list of valid tags stored in the station. If the tag is found as valid then the next step of service is allowed (charging begins, for example). If the tag is found to be new or invalid then a signal light (flashing yellow or similar) is given and the car driver is able to follow local instructions received via printed sign or message to their phone to validate their tag or register their payment information according to the business rules of the operator.

In one embodiment, a new customer may arrive at a station. For example, the new customer may arrive with a vehicle that does not have a corresponding entry in the list of preauthorized vehicles. In one embodiment, if no tag is read then a warning light (flashing red, for example) is given and the car driver is able to follow local instructions received via printed sign or message to their phone according to the business rules of the operator.

Embodiments disclosed herein may have several advantages over other previously available approaches. For example, since there is no network connection involved during the actual authentication event the station can provide service even during a communications outage or on an unreliable network. Furthermore, communication costs are reduced because they are not used for authentication even if available. Furthermore, since no payment information is collected or passed through the station customer security is enhanced and the costs of programming, data communications, and maintenance of the station are reduced due to the reduced sensitivity of data. There is also a reduced risk of the station being hacked or compromised in order to obtain customer identity or payment information because, in some embodiments, this information is never stored or used at the site. For example, payment and subscriptions may all be performed separately via a consumer computing device, rather than a fuel distribution station 102. As another matter, since the vehicle is uniquely identified, a consistent record of service for the specific vehicle (rather than an account or human operator) can be maintained and actual per vehicle usage information can be trusted for analysis and prediction. Furthermore, accounting and customer service costs are dramatically reduced since there is no need to track details or provide for credits on individual charging station events. Service is simply enabled or disabled. This leads to an ability to provide more competitive service and/or higher operating margins to refueling station operators.

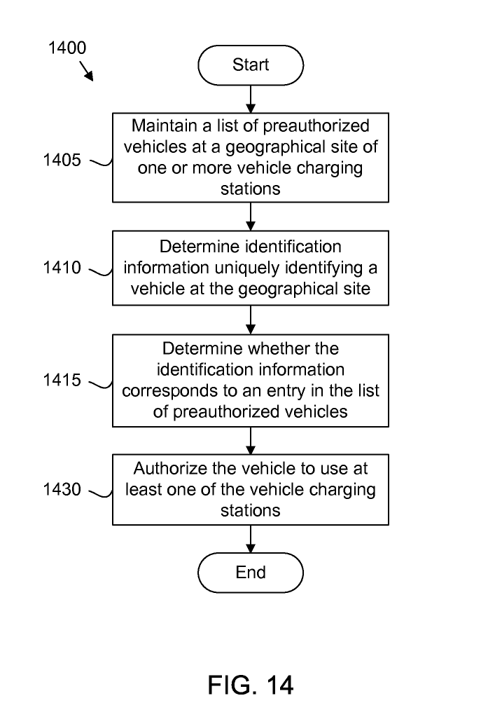

FIG. 14 is a schematic block diagram illustrating a method 1400 for authorizing a vehicle to use a refueling station. For example, the method 1400 may be performed by a site controller 110 to authorize use of a fuel distribution station 102 for refueling.

The method begins and a list component 202 maintains 1405 a list of preauthorized vehicles at a geographical site of one or more vehicle charging stations. The list of preauthorized vehicles may include entries uniquely corresponding to specific preauthorized vehicles.

A receiver component 204 determines 1410 identification information uniquely identifying a vehicle at the geographical site. For example, the receiver component 204 may determine 1410 the identification information based on information received from one or more sensors. The identification information may include an identifier received from a tag on the vehicle, a VIN received from a wireless dongle inserted into a diagnostic port, license plate information, an identifier of an inductive charging interface, or the like.

An entry component 210 determines 1415 whether the identification information corresponds to an entry in the list of preauthorized vehicles local to the geographical site. For example, the entry component 210 may search the list for the identification information. An authorization component 206 authorizes 1430 the vehicle to use at least one of the vehicle refueling stations in response to the list comprising an entry corresponding to the identification information. For example, the authorization component 206 may send an authorization or refueling command to the vehicle refueling station(s).

Various aspects of certain embodiments may be implemented using hardware, software, firmware, or a combination thereof. As used herein, a software component may include any type of computer instruction or computer executable code located within or on a non-transitory computer-readable storage medium. A software component may, for instance, comprise one or more physical or logical blocks of computer instructions, which may be organized as a routine, program, object, component, data structure, etc., that performs one or more tasks or implements particular abstract data types.

In certain embodiments, a particular software component may comprise disparate instructions stored in different locations of a computer-readable storage medium, which together implement the described functionality of the component. Indeed, a component may comprise a single instruction or many instructions, and may be distributed over several different code segments, among different programs, and across several computer-readable storage media. Some embodiments may be practiced in a distributed computing environment where tasks are performed by a remote processing device linked through a communications network.

The systems and methods disclosed herein are not inherently related to any particular computer or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communications network.

Software embodiments may be implemented as a computer program product that comprises a non-transitory storage medium configured to store computer programs and instructions that, when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, a digital-video disk, a magnetic tape, a Bernoulli drive, a magnetic disk, a punch card, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing the processes, apparatuses, and systems described herein. Accordingly, the present embodiments are to be considered illustrative and not restrictive, and the invention is not to be limited to the details given herein, but may be modified within the scope and equivalents of the appended claims.

As used herein, the terms “comprises,” “comprising,” and any other variation thereof are intended to cover a non-exclusive inclusion, such that a process, a method, a system, an article, or an apparatus that comprises a list of elements does not include only those elements but may include other elements not expressly listed or inherent to such process, method, system, article, or apparatus.

It will be obvious to those having skill in the art that many changes may be made to the details of the above-described embodiments without departing from the underlying principles of the invention. The scope of the present invention should, therefore, be determined only by the following claims.

1. A computer-readable storage medium comprising program code for causing one or more processors to perform a method, the method comprising:
maintaining a list of preauthorized vehicles wherein the list of preauthorized vehicles comprises entries uniquely corresponding to specific preauthorized vehicles, wherein the list is maintained at a geographical charging site remote from one or more geographical charging locations;
transmitting to the geographical charging sites an update to the list of preauthorized vehicles, wherein each geographical charging site comprising one or more charging stations; and
receiving usage updates for the one or more geographical charging sites.

2. The computer-readable storage medium of claim 1, wherein transmitting the update comprises transmitting on an update period, wherein the update period comprises a length of one or more of about an hour or more, about a day or more, about a week or more, and about a month or more.

3. The computer-readable storage medium of claim 1, wherein transmitting the update comprises transmitting the list.

4. The computer-readable storage medium of claim 1, wherein receiving the usage updates comprises one or more of:
a progress report for a recharging session;
a session report for a recharging session; and
an opening or closing of a gate to a charging station.

5. The computer-readable storage medium of claim 1, the method further comprising sending usage updates to a mobile device corresponding to an owner of the vehicle regarding usage of a charging station in relation to the vehicle.

6. The computer-readable storage medium of claim 1, wherein transmitting to the charging site comprises transmitting to a site controller for the charging site, wherein the site controller controls operation of the one or more charging stations.

7. The computer-readable storage medium of claim 6, wherein transmitting to each geographical charging site comprises transmitting a push message to a corresponding site controller.

8. The computer-readable storage medium of claim 1, wherein maintaining the list comprises:
receiving vehicle identity and model data with payment data for a new vehicle;
processing payment for the new vehicle based on the payment data; and
updating the list to include information corresponding to the vehicle.

9. A method comprising:
maintaining a list of preauthorized vehicles at a geographical site of one or more vehicle charging stations, wherein the list of preauthorized vehicles comprises entries uniquely corresponding to specific preauthorized vehicles;
determining identification information uniquely identifying a vehicle at the geographical site;
determining that the identification information corresponds to an entry in the list of preauthorized vehicles local to the geographical site; and
authorizing the vehicle for use of at least one of the vehicle charging stations.

10. The method of claim 9, wherein maintaining the list comprises receiving updates to the list from a central server.

11. The method of claim 10, wherein receiving the updates comprises receiving on an update period comprising a length of one or more of about an hour or more, about a day or more, about a week or more, and about a month or more.

12. The method of claim 10, wherein receiving the updates comprises receiving a push message from the central server.

13. The method of claim 9, wherein determining the identification information comprises determining the identification information based on one or more of information on the vehicle or information electronically stored on the vehicle.

14. The method of claim 9, further comprising detecting a presence of the vehicle at the geographical site, wherein determining the identification information comprises determining in response to detecting the presence of the vehicle.

15. An apparatus comprising:
a list component configured to maintain a list of preauthorized vehicles at a geographical site of one or more vehicle charging stations, wherein the list of preauthorized vehicles comprises entries uniquely corresponding to specific preauthorized vehicles;
a receiver component configured to determine identification information uniquely identifying a vehicle at the geographical site;
an entry component configured to determine whether the identification information corresponds to an entry in the list of preauthorized vehicles local to the geographical site; and
an authorization component configured to authorize the vehicle to use at least one of the vehicle charging stations in response to the list comprising an entry corresponding to the identification information.

16. The apparatus of claim 15, wherein the receiver component is configured to determine the identification information based on one or more of information on the vehicle or information electronically stored on the vehicle.

17. The apparatus of claim 16, wherein the receiver component is configured to determine the identification information based on an image of the vehicle captured by a camera.

18. The apparatus of claim 16, wherein the receiver component is configured to determine the identification information based on information received from a wireless radio of the vehicle.

19. The apparatus of claim 16, wherein the receiver component is configured to determine the identification information based on information received from a wireless charging interface of the vehicle.

20. The apparatus of claim 16, wherein the receiver component is configured to determine the identification information based on a wireless radio frequency identification (RFID) tag physically mounted on the vehicle.
